(19) United States
(12) Patent Application Publication
(10) Pub. No.: US 2003/0142040 A1
(43) Pub. Date: Jul. 31, 2003

(54) Display device with a fiber-optic projector, method of fabricating the display device, and display method

(76) Inventors: Ekkehard Gaydoul, Gross-Bieberau (DE); Andreas Ebbecke, Wiesbaden (DE)

Correspondence Address: LERNER AND GREENBERG, P.A., PATENT ATTORNEYS AND ATTORNEYS AT LAW, Post Office Box 2480, Hollywood, FL, 33022-2480, US

(21) Appl. No.: 10/353,462

(22) Filed: Jan. 29, 2003

(30) Foreign Application Priority Data
Jan. 29, 2002 (DE) 102 03 535.0
Jun. 14, 2002 (DE) 102 26 715.4

(51) Int. Cl. G09G 5/00

(52) U.S. Cl. 345/4

(57) ABSTRACT

A display device has a fiber optic projector for the luminous display of graphical representations. The projector has a fiber optic component with a projector input connected via optical conductors to a projector output. The projector input receives an input image that is transmitted to the projector output through optical conductors, for display as an output image with a display unit. Instead of sorting the optical conductor ends and combining them in a corresponding arrangement with identical assignment at the input and output sides, they are rather arbitrarily positioned such that the ends are irregular at the input as compared to the output. That is, the projector input and projector output are formed by combined optical conductor ends situated respectively opposite one another, that the optical conductor ends on the input and/or output sides are assigned to one another irregularly. The input image is fed into the projector input in modulated fashion and the output image at the projector output corresponds to the graphical representation.

### BACKGROUND OF THE INVENTION

1. Field of the Invention

The invention relates to a display device with a fiber optic projector for the luminous display of graphical representations. The system has a fiber optic component that has a projector input connected via optical conductors to a projector output, for receiving an input image. It is thereby possible for the input image to be transmitted to the projector output via the optical conductors and to be displayed as an output image by way of a display unit.

The invention furthermore pertains to a method for the luminous display of graphical representations with a display device, and to a method for producing the display device.

Display devices of the generic type have the purpose of displaying graphical representations. Possible graphical representations in this case are both texts and pictograms, but also graphical animations of any type. The graphical representations can both be black and white, and they may also be monochromatic or polychromatic.

Various display devices are known for this purpose from the prior art. For example, LED systems are used wherein there are inserted in a display device individual LEDs which can be specifically switched on and off via a software controller, thus enabling the implementation of all desired characters, graphics and/or graphical animations. A disadvantage of these display devices is that each individual pixel and/or light spot is dedicated to a single color, and so there is no provision for changing the color of the individual light spot itself.

Again, in the course of their service life, LED displays disadvantageously lose light intensity and therefore change the rendition of color and light individually in different ways. Thus, in practice, differences in intensity of up to 35% between the most luminous and least luminous LEDs of the same age occur as early as after two years in conjunction with an average drop in intensity of around 20%. With white LEDs, the difference can even amount to integral factors, since the light intensity of these LEDs can drop down to a third in the same period. In order to ensure a uniform graphical appearance, and thus the legibility of the information to be displayed, it is necessary for the LED display of these display systems to be exchanged after a determined operating period. This gives rise to a large maintenance outlay and thus to considerable cost disadvantages.

In order to avoid these disadvantages, use is made of display devices that have fiber optic projectors. In these display devices, an input image is generated for the display in a luminous fashion and transmitted via optical conductors to the display unit and reproduced there as an output image. A fiber optic component comprising a plurality of optical conductors serves this purpose.

The fiber optic component is a constituent of the fiber optic protector having a projector input and a projector output. Projector input and projector output are assigned to the optical conductor ends respectively situated opposite one another. The optical conductor ends are combined in this case in such a way that the input image or output image can be subdivided into individual pixels, and at least each pixel is assigned to an optical conductor end.

The input image is received at the projector input of the fiber optic component and transmitted by the optical conductors to the projector output. The projector output is equipped in an appropriate way to display, by way of the display unit, pixels reproduced by the optical conductor ends on the output side.

Display devices of this type are known in the prior art. U.S. Pat. No. 5,053,765 describes a fiber optic projector with optical conductors that consist of a multiplicity of optical fibers. The optical conductors are coupled to a shutter that serves as imaging means for displaying graphical representations. The optical fibers are interwoven in such a way that substantially all the edges that occur on the display are removed.

U.S. Pat. No. 4,299,447 describes a fiber optic projector for displaying a multiplicity of computer-generated alphanumeric characters. These characters are applied for this purpose to a liquid crystal plate which changes its transparency as a response. Optical fibers preferably run from one side of the liquid crystal plate to a display. The characters are then reproduced on the display. This fiber optic projector serves the purpose of enlarging computer-generated display screen representations, the fibers increasing in diameter running from the liquid crystal plate to the display.

A similar purpose is served by the fiber optic projector disclosed in U.S. Pat. No. 5,150,445. That display system can be used for enlarged reproduction of miniaturized graphical representations. The display has an input and an output. The fibers of the output are integrated in a perforated plate, while those of the input form a projection surface on which an image can be projected that is reproduced in an enlarged fashion at the output.

Similarly, U.S. Pat. No. 5,532,711 describes a fiber optic projector. There, optical conductors are likewise provided for transmitting an input image that is fed in at a projection surface at the input and is reproduced on a projection surface at the output.

In the case of the display devices of the above-mentioned prior art, the optical conductors are arranged at the input in correspondence with the output in order to display the input image at the output. For this purpose, the optical conductor ends are sorted, and combined with a mutual defined arrangement on the input side or output side such that a pixel of the input image appears at the same site in the output image at the output. The arrangements of the optical conductor ends are therefore assigned in a defined fashion on the input and output sides.

It is disadvantageous in those prior art display devices that the production and mounting of such fiber optic projectors is complicated and expensive, since all the optical conductor systems mentioned require a defined relative assignment of the optical conductor ends on the input side or output side. Moreover, in the case of these systems, the use of optical conductors made from optical glass fibers is not expedient since, for reasons of flexibility, the optical conductors must preferably be produced as bundles with several hundred individual glass fibers, and this requires additional outlay on production. The fiber optic projectors of the prior art are therefore generally implemented from optical plastic cables that have the known optical and qualitative disadvantages by comparison with optical conductors made from glass fiber.

### SUMMARY OF THE INVENTION

It is accordingly an object of the invention to provide a display device with a fiber-optic projector, a display method, and a method of producing a display device, which overcomes the above-mentioned disadvantages of the heretofore-known devices and methods of this general type and to provide for a display device that is resistant to aging and easy to maintain, that can be produced simply and cost efficiently, and that permits images to be reproduced optimally in terms of light and color fastness.

With the foregoing and other objects in view there is provided, in accordance with the invention, a display device, comprising:

a fiber optic projector for a luminous display of a graphical representation;

a display unit connected to the fiber optic projector for displaying an output image;

the fiber optic projector having a fiber optic component with a plurality of optical conductors having first ends together forming a projector input for receiving an input image and second ends together forming a projector output, whereby the input image is transmitted to the projector output via the optical conductors for display as the output image by the display unit;

the first ends of the optical conductors and the second ends of the optical conductors being arranged at the projector input and the projector output in irregular arrangement relative to one another, and the input image being injected at the projector input in a modulated fashion and the output image at the projector output corresponding to the graphical representation to be displayed.

In other words, the invention provides for a solution by virtue of the facts that the projector input and projector output are formed by combined optical conductor ends situated respectively opposite one another, that the optical conductor ends on the input and/or output sides are assigned to one another irregularly, and that the input image can be fed in at the projector input in a modulated fashion such that the output image displayed at the projector output corresponds to the graphical representation to be displayed. It is an advantage of the fiber optic projector according to the invention to achieve an image of an input image that is optimal in terms of light and color fastness with the aid of a fiber optic component that can be produced cost effectively. For this purpose, the desired graphical representation to be displayed is fed into the optical conductors in a modulated fashion at the projector input in such a way that the output image reproduced at the projector output corresponds to the desired graphical representation.

In accordance with an added feature of the invention, the projector input and/or projector output are designed as image projection surfaces. The input image can be exposed onto the projection surface of the projector input in an advantageous way.

In accordance with an additional feature of the invention, the input image can be fed in at the projector input, preferably by means of an imaging device. It is therefore possible to produce the input image by means of known data processing technology or else with the aid of optical means, and to transmit it in accordance with the original image onto the optical conductor ends on the input side.

This is achieved according to the invention by virtue of the fact that the input image is modulated as a function of the assignment of the optical conductor ends, preferably with the aid of transformation means. In this case, each optical conductor transmits the part, corresponding to it, of the input image to the optical conductor end on the output side such that the pixels are reproduced at the projector output in accordance with their irregular distribution or in accordance with the assignment prescribed by the transformation means, and are displayed in their totality. The input image is modulated in this case from the desired graphical representation and has a surface pattern with pixels that corresponds to the different arrangement of the optical conductor ends at the projector input and at the projector output, which is given by virtue of the fact that the optical conductor ends are arbitrarily combined on the input and output sides.

This is achieved by virtue of the fact that the transformation means comprise a transformation matrix and a data processing unit for calculating the input image from image data of the graphical representation to be displayed and/or the output image. It is provided for this purpose that in order to generate the input image each pixel, represented by an optical conductor of the projector output, of the graphical representation can be modulated by the transformation matrix as a pixel of the projector input that corresponds to the arrangement of the end of the optical conductor at the projector input.

The transformation matrix therefore has the data of the irregular assignment of the optical conductor ends on the input and output sides. The output image corresponds to the graphical representation to be displayed as combined pixels by the optical conductor ends on the output side, the transformation matrix assigning the pixels of the output image corresponding pixels of the input image. From the desired graphical representation to be displayed, the data processing means produce the corresponding surface pattern that is to be picked up as an input image at the projector input by the optical conductor ends, transmitted by the optical conductors to the projector output and reproduced there as an output image.

It is provided for this purpose that the imaging device has at least one light source for generating the input image at the projector input, a color wheel having filter segments, preferably optimized to the saturated signal colors of red, yellow and/or green, an optical imaging unit for generating an image of the input image in the projector input, a DMD (differential mode delay) and/or DLP (digital light processing) chip and/or data processing means for generating graphical representations. It is possible in this case that the optical conductor ends are driven individually by light sources, and that each pixel is assigned at least one light source in order to produce the input image. The imaging device can be connected for this purpose to the data processing unit that controls the light sources.

As an alternative to this, the input image can be exposed onto the projector input by means of a light source. According to the invention, an imaging optical system is provided with the aid of which an image of the input image is projected onto the projector input. Depending on need, and as a function of the graphical representation to be displayed, it is also possible to use a color wheel in order to produce desired color effects at the output image. In principle, all the colors are provided in this case. For specific applications in traffic engineering, it is sufficient that the color wheel is optimized to the known signal colors of red, yellow and green. It is particularly advantageous in this case when the projector input is designed as a projection surface.

Furthermore, it has proved to be advantageous that the display unit has optical elements for generating an image of the output image at the projector output. This ensures that the output image as produced at the projector output is displayed with reference to application, the imaging optical system projecting the output image in the image format required for the envisaged use.

In order for an input image to be available in a modulated fashion at the projector input, it is provided that in that the data processing unit has means for generating, storing and/or modulating graphical representations to be displayed and/or input images. It is possible in this case that preproduced input images are available in stored form for predetermined applications and can be fed in directly at the projector input as required. It is also provided to store graphical representations that are modulated by the data processing unit when these are to be displayed. A further refinement according to the invention is provided by virtue of the fact that the graphical representations and/or the input images are produced by or at the data processing unit and further processed indirectly or directly. It is provided in this case that the graphical representations to be displayed comprise letters, numerals, pictograms, animations, preferably in a polychromatic representation.

An advantageous embodiment of the projector according to the invention is achieved by virtue of the facts that the projector input and/or projector output have at least a resolution of 1600 light spots per square meter, and that at least one optical conductor end is assigned to a light spot. This advantageously permits a display of the graphical representation at least in the format of 40×40 pixels or light spots, an optimal reproduction of the characters according to the invention being possible as a result. Also provided according to the invention are larger displays which may be implemented, for example, by means of a plurality of combined projectors, or by increasing the resolution of a projector. Smaller resolutions can likewise be used according to the invention.

A further refinement of the projector according to the invention is achieved by virtue of the fact that each optical conductor has at least one individual fiber optic cable with at least one plastic fiber and/or glass fiber, preferably a bundle of several hundred glass fibers. It is therefore advantageously possible to ensure a transmission of the input image that is light- and colorfast. The use of optical conductors composed of bundles of several hundred glass fibers, which preferably have a minimum diameter in each case, makes it possible, moreover, for the optical conductors to be installable with small bending radii.

Optimal imaging properties of the fiber optic projector are advantageously achieved by virtue of the fact that the individual fiber optic cables have the highest packing density at the common ends at the projector input and/or projector output.

According to the invention, the inventive display device serves for use in a display device for traffic routing installations, preferably as warning installations for speed congestion and/or fog, as rerouting and/or construction site displays, for displays at airports, railway stations and/or bus terminals, and/or for advertising panels and/or for machines or equipment, preferably as an optical display. This also renders possible large scale displays that are preferably connected by data networks to one another or to a central data processing unit. Also possible are displays on machines and equipment, in the case of which, for example, the imaging is to be performed at a specific distance from the image reproduction. Further applications that are named in the prior art for such display systems are also likewise covered by the invention.

With the above and other objects in view there is also provided, in accordance with the invention, a method for the luminous display of graphical representations, which comprises:

feeding an input image into the projector input of the fiber optic component according to the above summary, the input image being in modulated form relative to the graphical representation to be displayed;

conducting components of the input image via the optical conductors to the projector output to form an output image; and

displaying the output image representing the graphical representation.

That is, the advantages are achieved by methods according to the invention for the luminous display of graphical representations. It is provided in this case by means of one of the above-named display devices that the input image modulated from the graphical representation to be displayed is fed in at the projector input, preferably with the aid of imaging means.

It is provided for this purpose that for the purpose of display the input image is calculated, preferably with the aid of transformation means, from the image data of the graphical representation to be displayed and is stored, and that for the calculation the graphical representation is decomposed into pixels that represent the arrangement of the ends of the optical conductors at the projector output, such that the pixels of the projector output are arranged by means of a transformation matrix in accordance with the arrangement of the corresponding ends of the optical conductors at the projector input.

A development of the method in accordance with the invention is made available by virtue of the fact that by means of an imaging device the pixels of the input image are fed in each case into the assigned optical conductors at the projector input of the fiber optic component. It is provided, furthermore, that the output image at the projector output is displayed by means of a display unit, preferably by means of optical elements. As a result, the output image displayed at the projector output can be further conditioned optically in order to permit optimal reproduction of the graphical representation by the projector.

There is also provided, in accordance with the invention, a method for producing the display device as summarized above. The fabrication method comprises combining the optical conductors in irregular arrangement at first ends thereof to form a projector input, each optical conductor representing a pixel of the projector input and of the projector output, and generating a transformation matrix assigning each pixel of the projector output a pixel of the projector input.

The method for producing one of the above-named display devices combines the optical conductors irregularly at the ends to form a projector input. Each optical conductor represents a pixel of the projector input and of the projector output, and a transformation matrix is generated that assigns each pixel of the projector output a pixel of the projector input. This ensures cost effective production of the projector according to the invention, it being possible for the optical conductor ends to form the projector input and the projector output without defined assignment. The irregular assignment of the optical conductor ends at the projector input or at the projector output is taken into account by means of the transformation matrix.

Moreover, it is provided according to the invention that at the ends situated opposite the projector input the optical conductors are arranged as a projector output in the form of a display matrix. The output image can thus be represented in a format that is enlarged by comparison with the input image. Whereas the optical conductors are combined in the densest possible packing at the projector input, it is possible, depending on requirement, for the optical conductor ends on the output side to be arranged in the display matrix such that they are more or less spaced apart from one another, as a result of which the display can be represented in an enlarged fashion.

The specific data for a fiber optic projector that ensure optimal reproduction of the graphical representation with the aid of the display device are provided according to the invention by virtue of the fact that the assignment of the pixels is determined by determining corresponding surface patterns at one end of the fiber optic component in conjunction with exposure of the other end of the fiber optic component with at least one standardized surface pattern, and the assignment data are stored as a transformation matrix.

It is provided for this purpose in an advantageous way that the projector input is divided into submatrices in order to generate the transformation matrix, that the submatrices are successively illuminated and the positions of the luminous optical conductors of the projector output are simultaneously determined at the projector output, and that the determined assignments of the optical conductor ends at the projector input to those at the projector output are stored.

It has proved to be advantageous, furthermore, that the generation of the transformation matrix and/or the assignment file is performed by means of a computer-controlled system that controls the illumination of the submatrices of the projector input, the detection of the luminous optical conductors at the projector output and the generation and/or storage of the transformation matrix. This allows the assignment data to be determined quickly and accurately.

It is possible in this case when producing the display device or the fiber optic projector to dispense with taking explicit account of any possible splitting up of the optical conductors into individual fibers at the projector input or at the projector output. Moreover, there is no need for a definite assignment of the arrangement of optical conductor ends at the input or output side, it thereby being possible to reduce considerably the time spent on mounting. This gives rise to further cost advantages. Moreover, the fiber optic component provided for the display device can be easily preproduced, and diversely used, for different applications.

Furthermore, a defined image production, and thus an assignment of the image information by means of the modulated input image of the motif to be produced at the projector input, is ensured as a function of the arrangement of the oppositely situated optical conductor ends at the projector output.

The first step for this purpose is to produce a transformation matrix that is stored as assignment file. The latter is specific to the respective fiber optic projector, and can be used for all motifs to be produced. In order to produce a transformation matrix, during the production the complete matrix of the imaging device, which preferably has a standard resolution of, for example, VGA 640×480 pixels, SVGA 800×600 pixels, XGA 1024×768 pixels, SXGA 1280×1024 pixels, division into submatrices of size n×m pixels is undertaken according to the invention. Each of these matrices is successively illuminated, and the system response is detected on the display device via a sensitive camera unit. The assignment is carried out in this case for each submatrix. Each assignment file or transformation matrix thus characterizes a fiber optic component in a unique way similar to a fingerprint. The character to be reproduced by the display device is converted by the data processing unit with the aid of the assignment file and made available at the imaging device.

Furthermore, according to the invention the advantage is achieved that the reproduction of the graphical representation to be displayed can be performed in a fashion resistant to aging, durably and reliably, with color and light fidelity and without degradation. The imaging device can be positioned separately from the display site, it thereby being possible to exclude damaging environmental effects.

It proves to be advantageous, furthermore, that the only part of the fiber optic projector that is subject to wear is the light source, which has an average service life of approximately 10,000 h and can be used in an easily exchangeable fashion, as a result of which the outlay on maintenance, and the costs associated therewith, also remain low.

Other features which are considered as characteristic for the invention are set forth in the appended claims.

Although the invention is illustrated and described herein as embodied in a display device with a fiber optic projector and related methods, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a schematic block diagram of a display device assembly according to the invention;

FIG. 2 is a schematic of an exemplary embodiment of an imaging device; and

FIG. 3 is a block schematic illustrating the process of image conditioning for the display.

### DESCRIPTION OF THE PREFERRED EMBODIMENTS

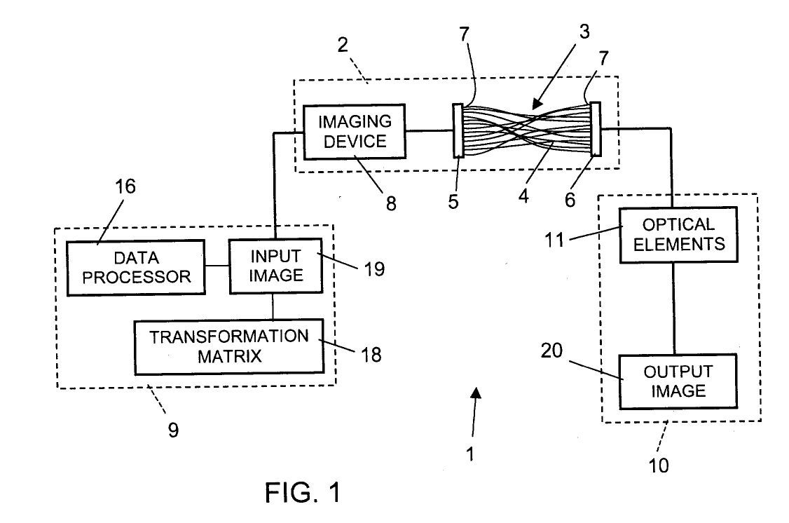

Referring now to the figures of the drawing in detail and first, particularly, to FIG. 1 thereof, there is shown an assembly with a display device 1 according to the invention. The display device assembly has a fiber optic projector 2 with a fiber optic component 3. The fiber optic component 3 comprises optical conductors 4 that are combined at the end for the purpose of receiving an input image at the projector input 5. The input image is transmitted via the optical conductors 4 to the projector output 6, the projector output 6 being formed by the optical conductor ends 7 situated opposite the projector input 5.

An imaging device 8 is provided for producing an input image at the projector input 5. The imaging device 8 is assigned a transformation device 9 that can be used to modulate an input image from the graphical representation provided for the display, which is fed in at the projector input 5.

The projector output 6 is assigned a display unit 10 that has optical elements 11 for displaying the output image reproduced at the projector output 6. The output image corresponds to the desired graphical representation.

The input image fed in at the projector input 5 is transmitted by the fiber optic projector 2 in order to display the graphical representation, the combined optical conductor ends 7, which are situated opposite one another in each case, being assigned to one another irregularly on the input and/or output sides. The input image fed in at the projector input 5 is subdivided in this case into pixels or light spots that are assigned in each case to an optical conductor end 7. The input image is modulated in this case such that after the transfer by the fiber optic component 3 the pixels of the input image are reproduced by the irregularly guided optical conductors 4 at the projector output 6 in an ordered way, corresponding to the graphical representation, as output image.

The output image displayed at the projector output 6 therefore corresponds to the graphical representation to be displayed to the extent that the reproduction appears as a matrix of the optical conductor ends 7.

Conditioning the output image by means of the display unit 10 permits the output image to be displayed in a desired format.

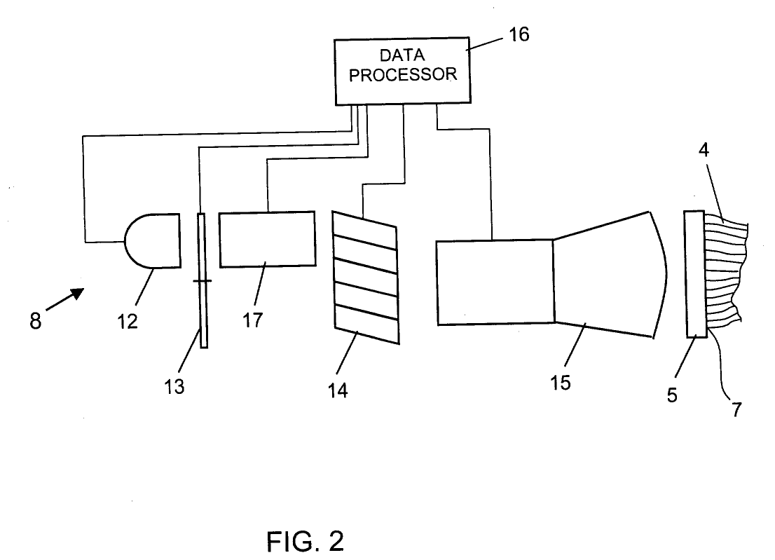

An imaging device 8 is illustrated in FIG. 2. The imaging device 8 comprises a light source 12 for producing the input image at the projector input 5. Light is radiated onto a DMD and/or DLP chip 14 via a color wheel 13, which has filter segments and is preferably optimized to saturated signal colors of red, yellow, or green. The DMD and/or DLP chip 14 transmits the input image to the imaging optical system 15, by which it is projected optically onto the projector input 5. The DMD/DLP chip 14, the light source 12 and the color wheel 13 and also the imaging optical system 15 are driven by the data processing unit 16. The input image is made available by the data processing unit 16 at the DMD/DLP chip 14.

The projector input 5 is designed for this purpose as a projection surface. The optical conductor ends 7 on the input side are arranged in an optimal packing density.

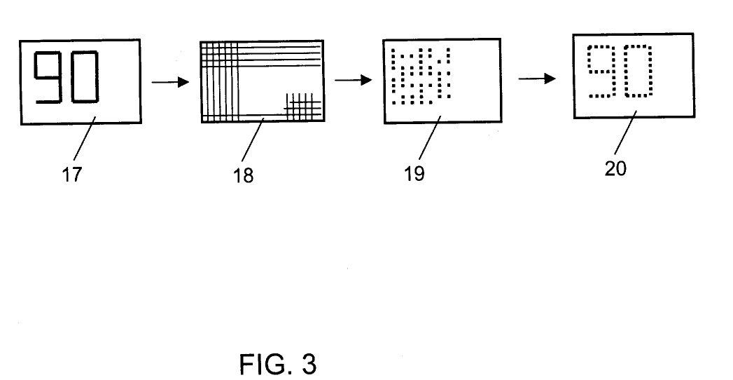

The cycle of the image modulation is illustrated schematically in FIG. 3. The graphical representation 17 to be displayed is converted by way of a transformation matrix 18 into the input image 19 and represented as output image 20 after transmission by the fiber optic projector 2.

A reverse procedure to this is adopted in order to produce the transformation matrix 18, the optical conductors 4 being arranged combined irregularly at the ends 7 to form a projector input 5 and a projector output 6, and each optical conductor represents a pixel of the projector input 5 and of the projector output 6. The transformation matrix 18 is produced by virtue of the fact that each pixel of the projector output 6 is assigned a pixel of the projector input 5.

For this purpose, the assignment of the pixels is determined by determining corresponding surface patterns at one end of the fiber optic component 3 in conjunction with exposure of the other end of the fiber optic component 3 with at least one standardized surface pattern. The projector input 5 is divided for this purpose into submatrices, and the submatrices are successively illuminated. At the same time, the positions of the luminous optical conductors 4, i.e., the illuminated conductors 4, are determined at the projector output 6. These assignment data are then stored as transformation matrix 18. The matrix 18, therefore, is representative of the respective fiber optic component 3.

The production of the transformation matrix 18 or the assignment file is effected by a computer-controlled system that controls the illumination of the submatrices of the projector input 5, the recording of the luminous optical conductors 4 at the projector output 6, and the production and storage of the transformation matrix 18.

We claim:

1. A display device, comprising:
a fiber optic projector for a luminous display of a graphical representation;
a display unit connected to said fiber optic projector for displaying an output image;
said fiber optic projector having a fiber optic component with a plurality of optical conductors having first ends together forming a projector input for receiving an input image and second ends together forming a projector output, whereby the input image is transmitted to said projector output via said optical conductors for display as the output image by said display unit;
said first ends of said optical conductors and said second ends of said optical conductors being arranged at said projector input and said projector output in irregular arrangement relative to one another, and the input image being injected at said projector input in a modulated fashion and the output image at said projector output corresponding to the graphical representation to be displayed.

2. The display device according to claim 1, wherein at least one of said projector input and said projector output is an image projection surface.

3. The display device according to claim 1, wherein the input image is injectable into said projector input.

4. The display device according to claim 1, which further comprises an imaging device for feeding the input image into said projector input.

5. The display device according to claim 3, which further comprises a transformation device for modulating the input image as a function of an assignment of said first optical conductor ends and said second optical conductor ends, respectively.

6. The display device according to claim 5, wherein said transformation device comprises a transformation matrix and a data processing unit for calculating the input image from image data of the graphical representation to be displayed or the output image.

7. The display device according to claim 6, wherein the input image is defined with a multiplicity of pixels, each represented by an optical conductor of said projector output, and the input image of the graphical representation is modulated by the transformation matrix as a pixel of the projector input corresponding to an arrangement of said first end of said optical conductor at said projector input.

8. The display device according to claim 1, wherein said imaging device has at least one light source for generating the input image at said projector input, a color wheel with filter segments, an optical imaging unit for generating an image of the input image in said projector input, one of a DMD chip and a DLP chip, and a data processing device for generating graphical representations.

9. The display device according to claim 8, wherein said filter segments of said color wheel are optimized to saturated signal colors of red, yellow, and green,

10. The display device according to claim 1, wherein said display unit has optical elements for generating an image of the output image at said projector output.

11. The display device according to claim 8, wherein said data processing device includes means for generating, storing, and modulating one of the graphical representation to be displayed and the input image.

12. The display device according to claim 1, wherein the graphical representation to be displayed is selected from the group consisting of letters, numerals, pictograms, and animations.

13. The display device according to claim 1, wherein the graphical representation to be displayed is a polychromatic representation.

14. The display device according to claim 1, wherein at least one of said projector input and said projector output has resolution of at least 1600 light spots per square meter, and wherein at least one said optical conductor end is assigned to each light spot.

15. The display device according to claim 1, wherein each said optical conductor has at least one individual fiber optic cable with at least one fiber selected from the group of plastic fibers and glass fibers.

16. The display device according to claim 1, wherein each said optical conductor has at least one individual fiber optic cable with a bundle of several hundred glass fibers.

17. The display device according to claim 15, wherein said individual fiber optic cables have a highest packing density at common ends at one of said projector input and said projector output.

18. A fiber optic projector, comprising:
a projector input;
a projector output;
a multiplicity of optical conductors having first ends together forming said projector input and having second ends together forming said projector output, whereby an input image received at said projector input is transmitted to said projector output via said optical conductors;
said first ends of said optical conductors and said second ends of said optical conductors being arranged at said projector input and said projector output in irregular arrangement relative to one another, and the input image being injected at said projector input in modulated form and an output image at said projector output having a different pixel arrangement from the input image.

19. The projector according to claim 18 configured for integration in a display device for traffic routing installations, for traffic warning installations, for rerouting displays, construction site displays, airport displays, railway station displays, bus terminal displays, advertising panels, displays for machines and equipment, and generic optical displays.

20. A method for the luminous display of graphical representations, which comprises:
feeding an input image into the projector input of the fiber optic component according to claim 1, the input image being in modulated form relative to the graphical representation to be displayed;
conducting components of the input image via the optical conductors to the projector output to form an output image; and
displaying the output image representing the graphical representation.

21. The method according to claim 20, which comprises modulating the input image with an imaging device.

22. The method according to claim 20, which comprises calculating the input image from image data of the graphical representation to be displayed and storing the input image, and thereby decomposing the graphical representation into pixels representing an arrangement of the second ends of the optical conductors at the projector output, such that the pixels of the projector output are arranged with transformation matrix in accordance with an arrangement of corresponding first ends of the optical conductors at the projector input.

23. The method according to claim 22, which comprises calculating the input image with a transformation device.

24. The method according to claim 20, which comprises injecting with an imaging device the pixels of the input image in each case into respectively assigned optical conductors at the projector input of the fiber optic component.

25. The method according to claim 20, which comprises displaying the output image at the projector output with a display unit.

26. The method according to claim 20, which comprises displaying the output image at the projector output with optical elements of a display unit.

27. A method for producing the display device according to claim 1, which comprises: combining the optical conductors in irregular arrangement at first ends thereof to form a projector input, each optical conductor representing a pixel of the projector input and of the projector output, and generating a transformation matrix assigning each pixel of the projector output a pixel of the projector input.

28. The method according to claim 27, which comprises arranging the second ends of the optical conductors distal from the projector input to form a projector output in the form of a display matrix.

29. The method according to claim 27, which comprises assigning the pixels by determining corresponding surface patterns at one end of the fiber optic component in conjunction with exposure of the other end of the fiber optic component with at least one standardized surface pattern, and storing assignment data as a transformation matrix.

30. The method according to claim 27, which comprises dividing the projector input into submatrices for generating the transformation matrix, successively illuminating the submatrices and simultaneously determining respective positions of the luminous optical conductors of the projector output, and storing the determined assignments of the optical conductor ends at the projector input to those at the projector output.

31. The method according to claim 30, which comprises generating one of the transformation matrix and the assignment file with a computer-controlled system controlling an illumination of the submatrices of the projector input, a detection of the luminous optical conductors at the projector output, and a generation and storage of the transformation matrix.
